(19) United States
(12) Patent Application Publication
(10) Pub. No.: US 2017/0061476 A1
(43) Pub. Date: Mar. 2, 2017

(54) SYSTEMS AND METHODS FOR CURATING AND DISPLAYING SOCIAL MEDIA CONTENT AND RELATED ADVERTISEMENTS ON DISPLAY DEVICES AT LIVE EVENTS

(71) Applicant: MetroStar Systems, Inc., Reston, VA (US)

(72) Inventors: Ali Reza Manouchehri, Reston, VA (US); Jorge Luis Vasquez, Fairfax, VA (US)

(21) Appl. No.: 14/839,607

(22) Filed: Aug. 28, 2015

(51) Int. Cl. G06Q 30/02; G06Q 50/00; G06F 17/30

(52) U.S. Cl. CPC G06Q 30/0252; G06F 17/30038; G06F 17/3005; G06Q 50/01; G06Q 30/0277

(57) ABSTRACT

A system includes a plurality of large screen display devices located at a venue, and a storage adapted to store one or more items of social media content having respective content tags. The system also includes one or more processors adapted to select a plurality of items of social media content having content tags matching one or more predetermined criteria, cause first items selected from the plurality of items of social media content to be displayed, during a live event occurring at the venue, on each of the plurality of large screen display devices, select a second item having a particular content tag from the first plurality of items of social media content, identify an advertisement image having an advertisement campaign tag that matches the particular content tag of the second item, and cause the second item and the advertisement image to be displayed, at a selected time during the live event, simultaneously on each of the plurality of large screen display devices.

### TECHNICAL FIELD

This disclosure relates generally to managing and displaying items of social media content and displaying advertisements related to the social media content.

### BACKGROUND

Social media has become a big part of the Internet. Many social media companies exist that allow users to post and share information to their network of friends. Usually an audience selected by the original user who posted or shared that data can only see the data. Monetizing on that data however, can be troublesome and burdensome because of the vast amount of data that need to be sifted through.

Many systems exist to present advertisements to large audiences, such as advertising displayed on websites via the Internet, etc. Advertising on social networking websites, for example, often is provided based on attributes, preferences, or activities of the user. However, a need exists for systems and methods to display items of social media content to large audiences at venues where live events (such as sporting events, conferences, events in public spaces, events in retail stores, events in kiosks or malls, events in movie theaters, etc.) are held, and to synchronize the display of advertisements with displays of related items of social media content at these venues.

### SUMMARY

In accordance with an embodiment, a system includes a plurality of large screen display devices located at a venue, and a storage adapted to store one or more items of social media content having respective content tags. The system also includes one or more processors adapted to select a plurality of items of social media content having content tags matching one or more predetermined criteria, cause first items selected from the plurality of items of social media content to be displayed, during a live event occurring at the venue, on each of the plurality of large screen display devices, select a second item having a particular content tag from the first plurality of items of social media content, identify an advertisement image having an advertisement campaign tag that matches the particular content tag of the second item, and cause the second item and the advertisement image to be displayed, upon the occurrence of a selected event during the live event, simultaneously on each of the plurality of large screen display devices.

In another embodiment, the plurality of large screen display devices include a jumbotron television screen, and the venue is a venue for sporting events.

In another embodiment, the selected event is one of a halftime of a game, a time between innings of a baseball game, and an interval between speeches by speakers at a conference.

In another embodiment, the plurality of items of social media content include one of a photo, a blog post, a tweet, and a video.

In another embodiment, the live event is one of a sporting event, a conference, a concert, a party, an event at a retail store, an event in a public space, an event at a kiosk in a mall, and an event at a movie theater.

In another embodiment, the one or more processors are further adapted to obtain the one or more items of social media content from one or more social media websites, enable a user to tag the one or more items of social media content to generate tagged items of social media content, and store the tagged items of social media content.

In another embodiment, the second item is displayed in a first region of each large screen display device and the advertisement image is displayed in a second region of the each large screen display device.

In accordance with another embodiment, a method is provided. A plurality of items of social media content having content tags matching one or more predetermined criteria are selected. First items selected from the plurality of items of social media content are displayed, during a live event occurring at a venue, on each of a plurality of large screen display devices located at the venue. A second item having a particular content tag is selected from the first plurality of items of social media content. An advertisement image having an advertisement campaign tag that matches the particular content tag of the second item is identified. The second item and the advertisement image are displayed, upon the occurrence of a selected event during the live event, simultaneously on each of the plurality of large screen display devices.

In accordance with another embodiment, a non-transitory computer readable medium includes instructions stored thereon, that, in response to execution by a computing device, cause the computing device to perform operations comprising selecting a plurality of items of social media content having content tags matching one or more predetermined criteria, causing first items selected from the plurality of items of social media content to be displayed, during a live event occurring at the venue, on each of the plurality of large screen display devices, selecting a second item having a particular content tag from the first plurality of items of social media content, identifying an advertisement image having an advertisement campaign tag that matches the particular content tag of the second item, and causing the second item and the advertisement image to be displayed, upon the occurrence of a selected event during the live event, simultaneously on each of the plurality of large screen display devices.

Other embodiments of these aspects include corresponding systems, apparatus, and computer-readable medium storing software comprising instructions executable by one or more computers, which cause the computers to perform the actions of the methods.

Further embodiments, features, and advantages, as well as the structure and operation of the various embodiments are described in detail below with reference to accompanying drawings.

### BRIEF DESCRIPTION OF THE FIGURES

Embodiments are described with reference to the accompanying drawings. In the drawings, like reference numbers may indicate identical or functionally similar elements.

FIG. 1 illustrates a system for an engagement platform.

FIG. 2 illustrates a system for an engagement platform.

FIGS. 3-12 are screenshots of the engagement platform.

FIG. 13 is a sequence diagram.

FIG. 14 illustrates a flowchart of an example process.

FIG. 15 is a diagram of an example computer device used to implement the system.

FIG. 16 shows a social content and advertisement synchronization system in accordance with an embodiment.

FIG. 17 shows a venue for a live event in accordance with an embodiment.

FIG. 18 is a flowchart of a method of displaying curated social media content on a display device during a live event in accordance with an embodiment.

FIG. 19 shows a photo displayed on a display device in accordance with an embodiment.

FIG. 20 shows a photo and an advertisement image displayed on a display device in accordance with an embodiment.

### DETAILED DESCRIPTION

Methods and systems will be described that allow users to collect and curate social media content, display the social media content, and display advertisements with the social media content in a synchronized manner.

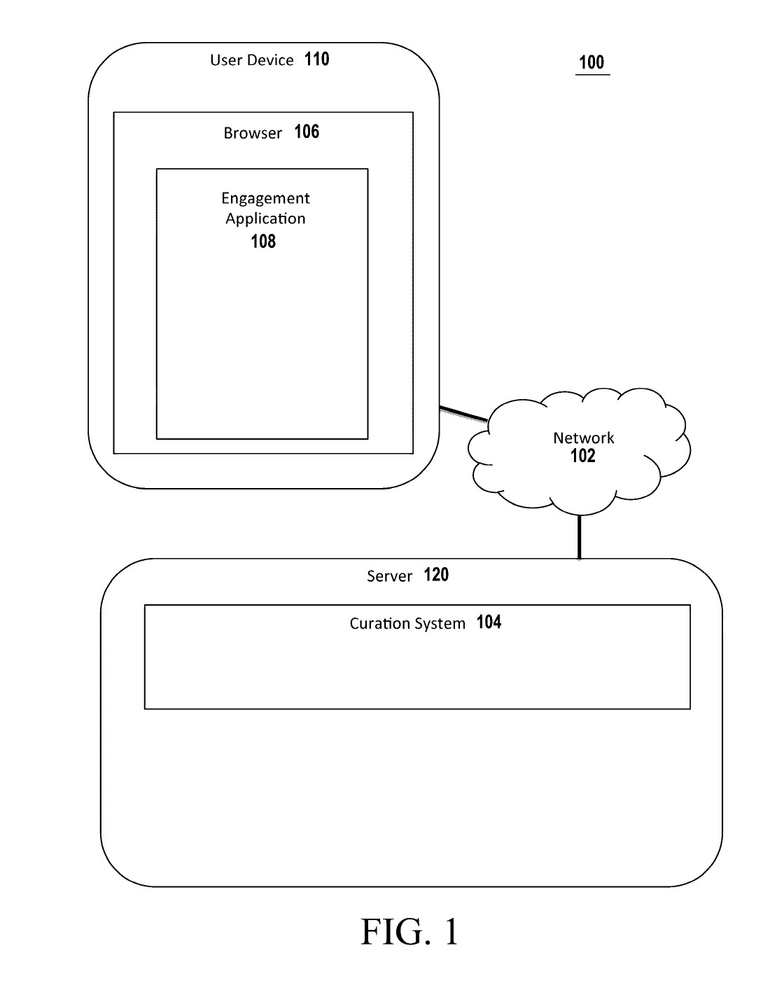

FIG. 1 illustrates an example of a networked system 100 of devices, which may be, for example, mobile devices such as mobile phones, tablets or computers. The devices may be networked over network 102. Network 102 may be any network or combination of networks that can carry data communications. Such a network 102 may include, but is not limited to, a local area network, metropolitan area network, and/or wide area network such as the Internet. Network 102 can support protocols and technology including, but not limited to, World Wide Web (or simply the “Web”), protocols such as a Hypertext Transfer Protocol (“HTTP”) and HTTPS protocols, and/or services. Intermediate web servers, gateways, or other servers may be provided between components of the system shown in FIG. 1, depending upon a particular application or environment.

A user may operate a user interface on user device 110 to create engagement content on server 120. User device 110 may be coupled to server 120 over network 102. Server 120 includes curation system 104, which may be used to provide information to user device 110. Engagement application 108 may be implemented on or implemented with one or more computing devices, such as user device 110.

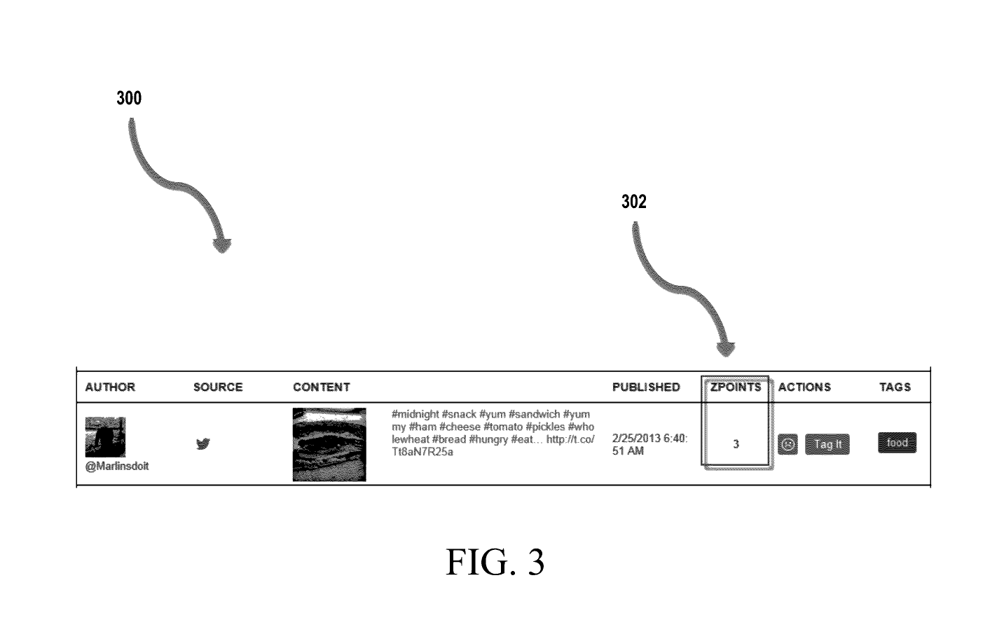

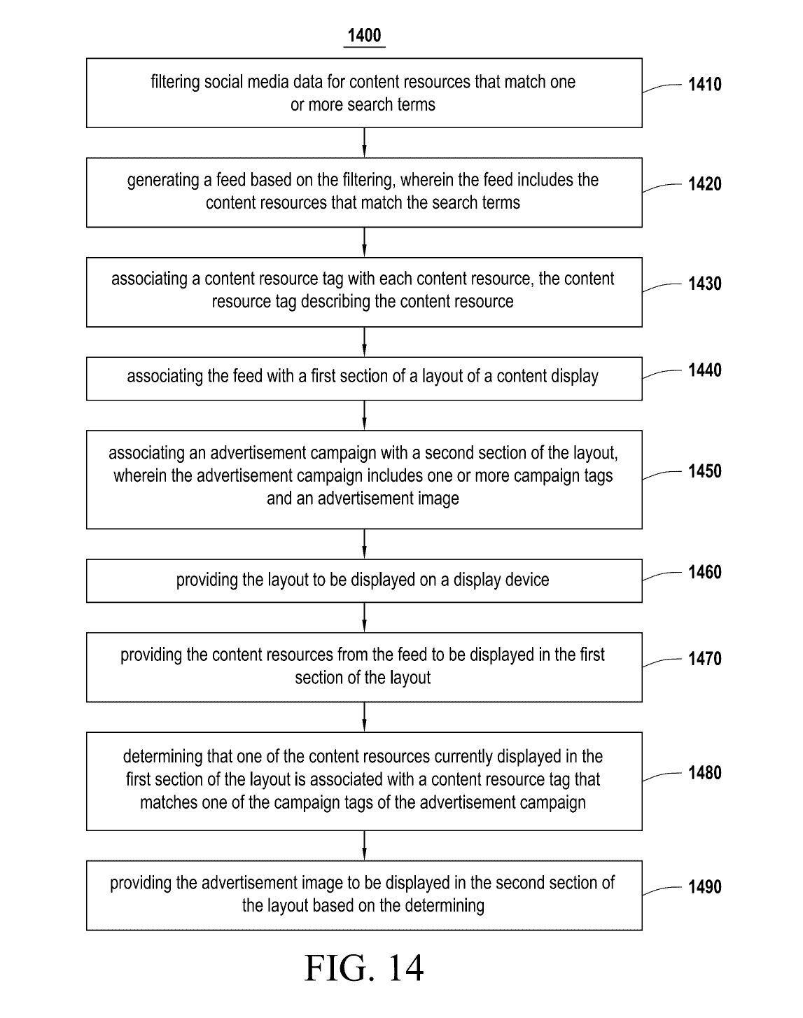

In one embodiment, the functionality of engagement application 108 and/or curation system 104 may be provided through a browser 106 on computing devices, such as user device 110. Curation system 104 on server 120 may host the service and serve it to device 110 and any other computing devices. Any combination of implementations may provide, through a browser, the functionality represented by the example implementations of systems 108 and 110 shown in FIG. 1 and in the screenshots and flowchart of FIGS. 3-14. Any stages shown in flowchart of FIG. 14 that involve displaying content may be considered to provide the content for display in a browser.

Browser 106 may be any commonly used browser, including any multi-threaded or multi-process browser. In one embodiment, the functionality of engagement application 108 can be provided through browser 106. The functionality of any of the components or flowcharts shown in the figures may be provided through the browser executed on device 110, server 120 or any other computing device. The web pages or application provided through the browser may be served from server 120, device 110, or any other computing device. Different windows or views may be shown through browser 106.

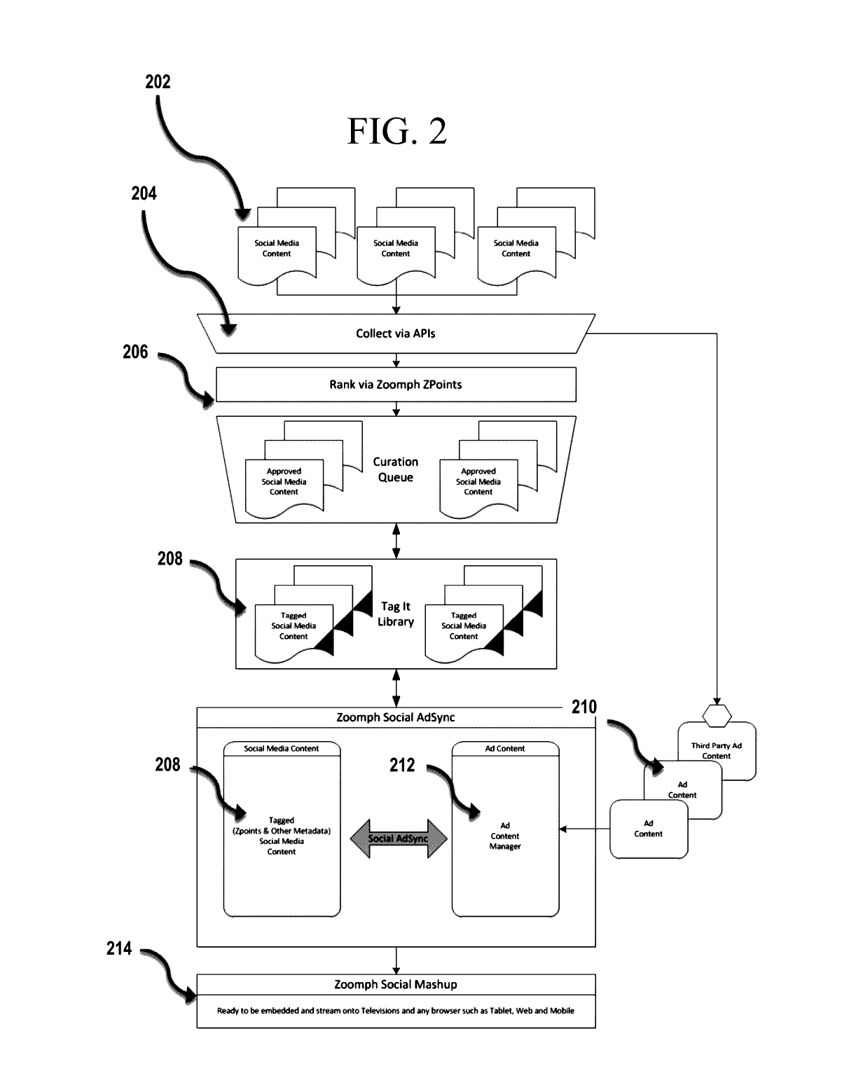

FIG. 2 is a block diagram 200 of the functionality of engagement application 108 and the curation system 104. The curation system 104 in combination with the engagement application 108 collects social content 202 by providing its users with the ability to retrieve content from social media platforms such as Twitter, Facebook and Instagram as well as others. Content is collected via Application Programming Interface (API) 204 from Twitter Stream API, Facebook Social Graph API, Instagram API, and other third party APIs.

Using points, users can rank social media content 206. One way users can rank content is by measuring its influence. Curation system 104 ranks the influence of social media content by using its own proprietary algorithm. The algorithm ranks the influence of social media content, as content is inserted onto the database, by providing a point score.

Points measure influence within the context of a social media conversation. With Points the influence of both who is speaking and what is being said can be measured. Points measures the influence of authors as well as the influence of the content shared on social media itself.

In one embodiment, the point system can use different factors to generate points for each content resource. There are four factors that can be used: the origination of the content resource, the content of the content resource (whether its images, text, or video), the number of subscribers (followers and friends) of the author of the content resource or the individual(s) that rebroadcast/reused the content resource, and the rating of the content resource (likes, favorites, comments, retweets, reply's, shares etc.). A like is an indication by a user that they prefer or they like a content resource. A favorite is when a user saves a content resource as a resource that they want to keep as a favorite. Each content resource can include comments by other users. A retweet is when a content resource is broadcast again by a different user. A share is when a user shares a content resource with one or more other individuals. Each of these likes, favorites, comments, retweets, replys, shares, etc can be counted for each content resource. Curation system 104 can combine these factors and these counts in a number of ways to determine the score, for example adding them or multiplying them.

In one embodiment, a weight can be assigned to different factors as well, for example, a weight of 3 may be added for a content resource that is liked versus a content resource that is not. Curation system 104 can apply the weight to each resource's count for example in determining the point score.

Curation system 104 can keep track of all the relevant data within a conversation, and utilizes the data to estimate the attention given to any author or piece of content.

The algorithm updates the Points score for social media content at predefined intervals to constantly serve the most real-time Points score, as shown in FIG. 3. FIG. 3 displays one piece of content 300. The points score shown is ZPoints 302. In this example, the Points are called Zpoints but can be called by any name. The Points scores are updated in real-time to reflect the potentially rapid additions, changes, etc. to social media conversations. Items, authors and feeds' influence are accumulated over time to show cumulative totals of influence for each item, author or feed.

In one embodiment, social media content can be curated. In a curation queue in curation system 104, users can view content and determine an action to take on that content. The curation queue provides its users with the ability change the status of social media content, or content resources, with status such as Pending, Approved, Rejected, Spam, Q&A. Users can tag each content piece or content resource. Tagging is the ability to take social media content and append additional metadata. Tagging is done in order to classify and organize social media content so that the system can serve up the most applicable social media content alongside the appropriate advertisements. Tagged social media content 208 can then be created. The tagged social media content 208 can be matched with ad content 210 by an ad manager 212. A content display 214 can be generated with the tagged social media content 208 and the ad content 210.

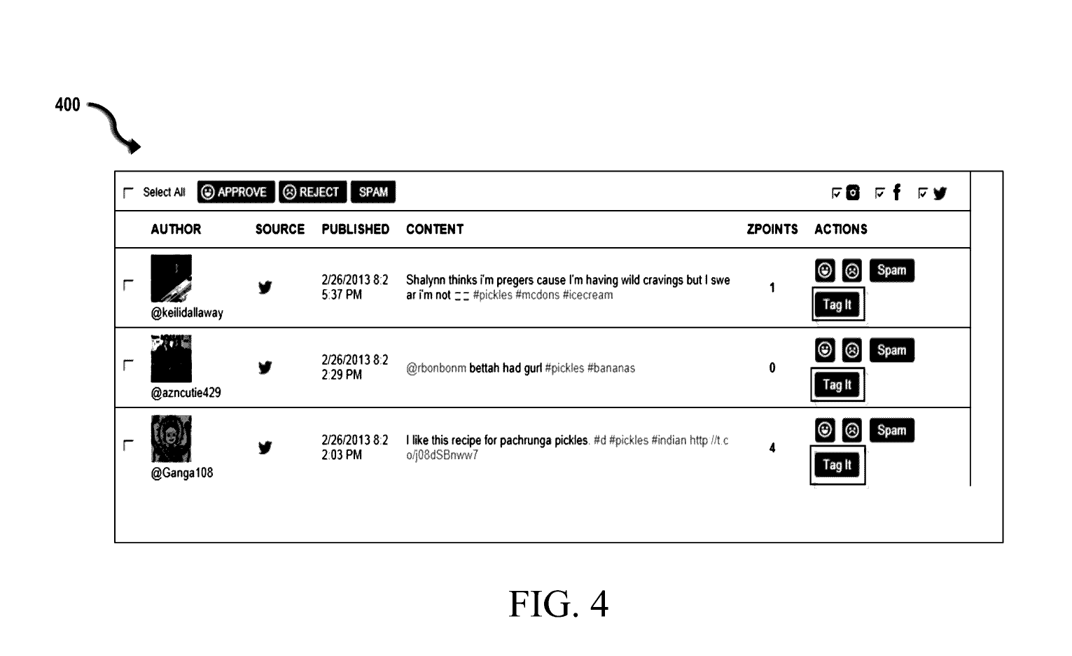

FIG. 4 shows a curation queue 400 with tagging functionality. Curation system 104 tags social media content by providing a tagging functionality. The tagging functionality provides for various tagging features. Manual text Tagging is a feature to allow users to manually tag social media content. Intelligent Text Tagging is feature to auto-tag text-based social media content.

The process to manually tag can be summarized in four steps. The user identifies content to be tagged in the curation queue. The user clicks the “tag it” button associated with the item. Engagement system 108 can prompt the user to type in a keyword in a free-form text field. Engagement system 108 appends that keyword metadata to the social media content resource and save the tag in the “Tag It” Library. Curation system 104 can store the keyword metadata appended to the social media content resource.

Intelligent image tagging is a feature to auto-tag image-based social media content. The process to intelligent image tagging can be summarized in four steps. Curation system 104 automatically identifies an image within the social media content resource to be tagged in the curation queue. Curation system 104 leverages image recognition services (internally or via third party API) to processes and recommend tags.

Curation system 104 can include an image recognition service that can identify objects in images (logos, Places, Faces, Products, Text). The objects can be sent to a service to be identified. For example, a third party service that can identify objects in images. In another embodiment, a database can be would be used as a service, that would match database object, which would be pre-tagged with metadata. These database objects, would then be compared against image objects. If a match is made, then the tags from the database objects are copied onto the image object.

The service then provides us additional information in the form of tags (metadata) for the objects through the API back to curation system 104.

Curation system 104 can access a “Tag It Library” to retrieve any existing and applicable tags or creates a new tag to append as metadata to the specific social media item (image). A user can override or adjust the tag that was automatically associated with the image for verification and accuracy.

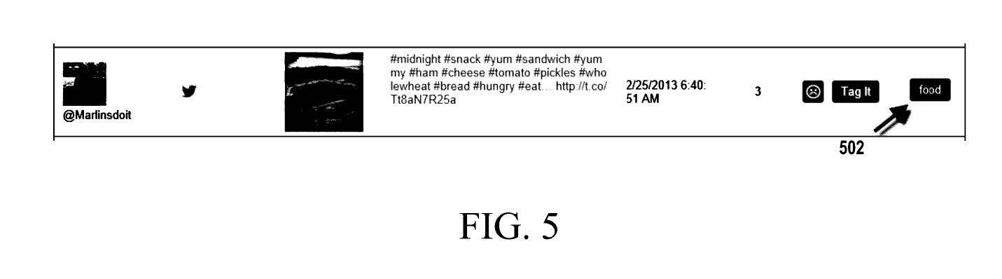

In one embodiment, in the manual tagging process, a user is able to click on a “Tag It” button in the curation queue, as well as being able to create tags, and use existing tags, and attach one or more tags to social media content. A use can click on a “Done” button in order to save the selected tag(s). As shown in the example, the tag can then appear alongside the actions in the “Tag” column ‘Food’ as shown in the tag 502 of FIG. 5

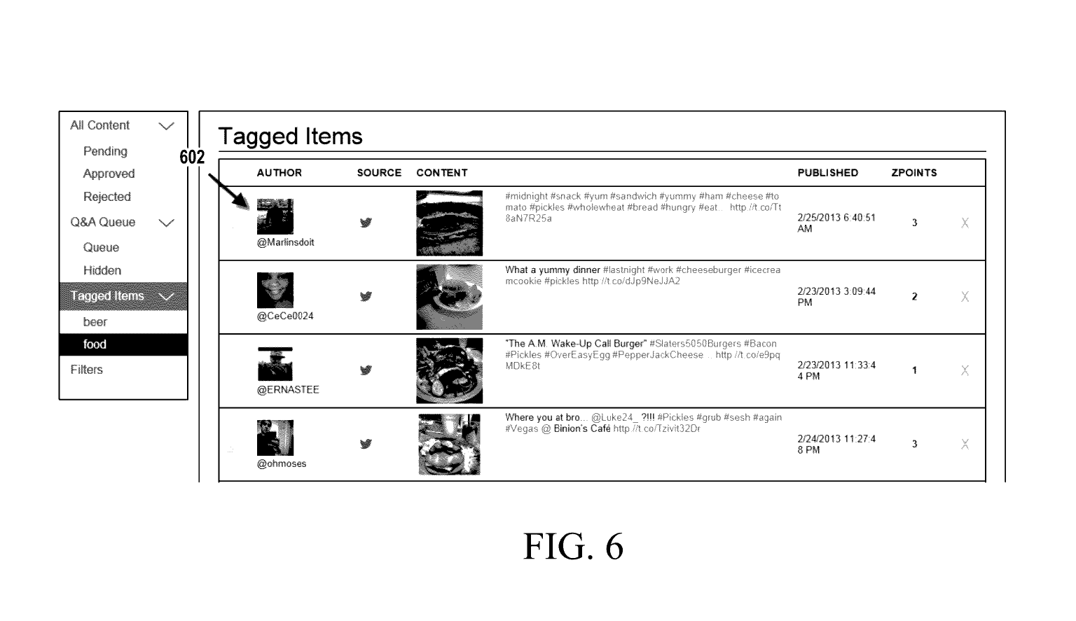

By saving the selected tag, the social media content can appear under the “Tagged Items Queue” 602 as shown in FIG. 6. If a user needs to remove a tag from an item they can do so from the “Tagged Items Queue” by clicking the “x” alongside the content. Once a tag is added to social media content, it is instantly available for use by curation system 104.

In one embodiment, curation system 104 provides the ability to create content displays, or they may be called Social Mashups, which are a combination of various data: curated, tagged social media content (text and images) ranked by points and advertisements (uploaded through the curation system 104 or integrated through 3^{rd} party ad engines).

Curation system 104 allows users to bring together relevant and influential data, based on points scores, social media content from multiple platforms and conversations by selecting: 1. A layout to display social media content alongside relevant ads 2. social content types: trends clouds, streaming social content, and streaming Social pictures 3. ad content, and 4. conversation source, which are feeds.

A feed is a social media conversation defined by designated search terms i.e. keywords, #hash tags and @handles. The feed includes social media data that is curated.

Trend clouds are visual depictions of frequently used words in social media conversations. Streaming social content relates to scrolling text displaying the curated and tagged text. Streaming social pictures are revolving photos displaying the curated and tagged images. Again, all influential social media content would be ranked and selected to be used with points.

A content display combines various data; curated, tagged social media content (text and images) ranked by points, and advertisements (uploaded through content curation system 104 or integrated through 3^{rd} party ad engines).

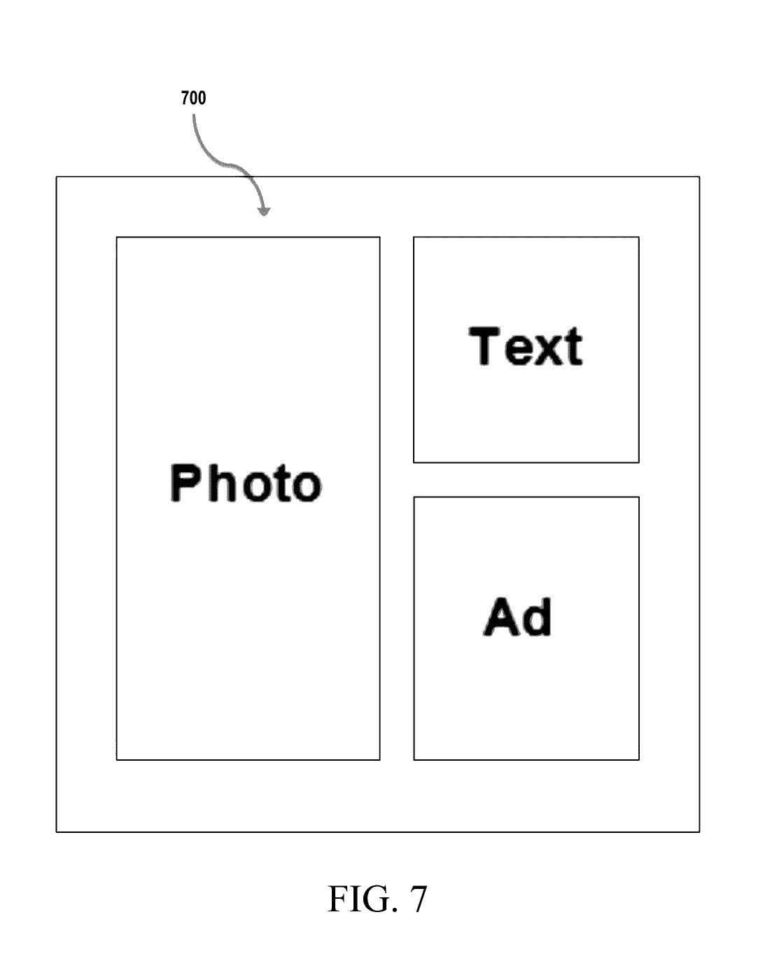

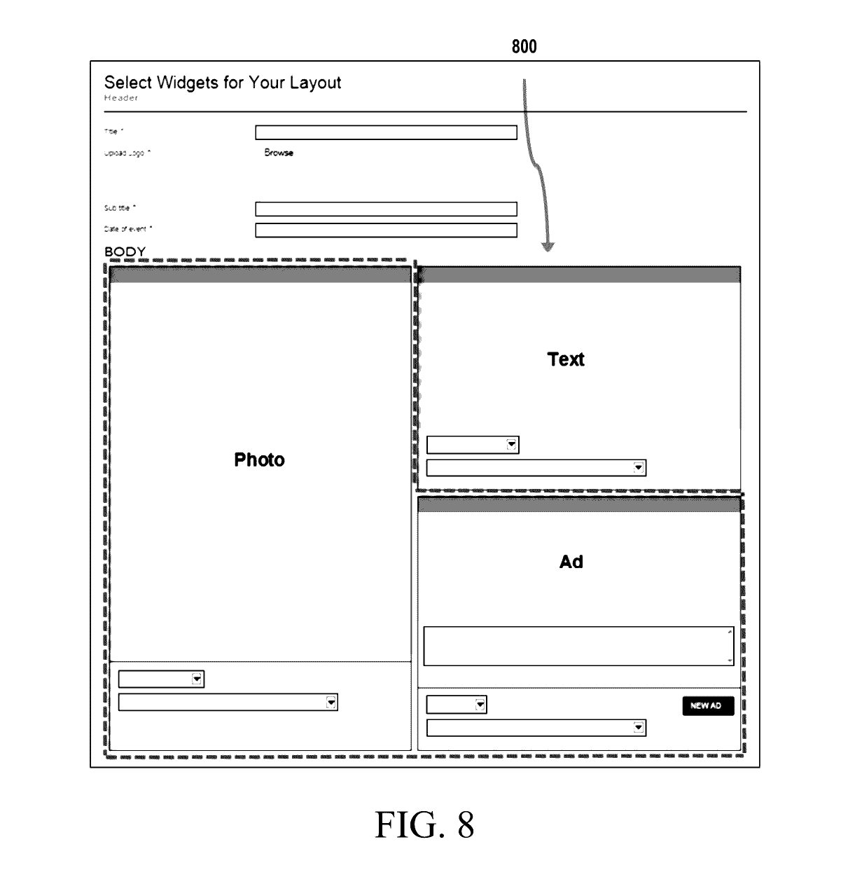

In one embodiment, to build a content display a user can select a layout that includes advertisements. A content display 700 is shown in FIG. 7. A user can configure the content display, within the selected layout 800 as shown in FIG. 8.

Advertisements can be configured through the ad content by defining an ad campaign and associating a tag to an ad campaign. A user can define the ad campaign and associate one or more tags to each ad campaign.

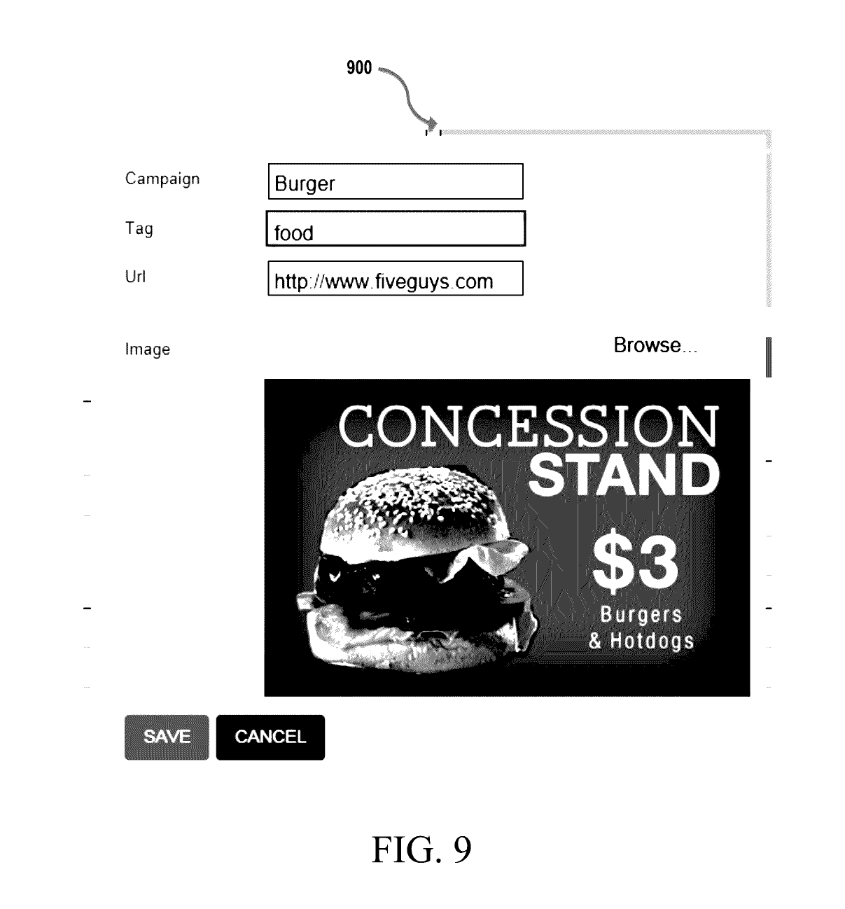

A user is able create a new ad campaign and to associate the campaign with a tag previously established through the curation queue. Users can also create a brand new tag within this step. A new ad 900 is shown in FIG. 9. Users can also leverage a “Tag It” library, which saves previously saved tags.

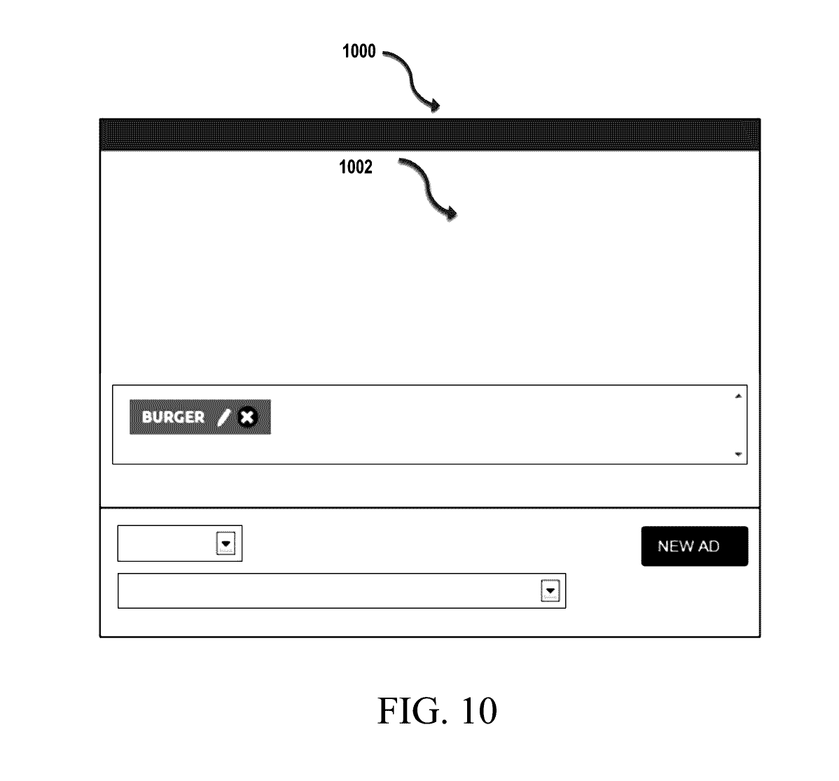

FIG. 10 is an ad widget 1000 within the content display. A user can to create multiple “Ads” to appear in the ad content area 1002 shown in FIG. 10. All tags selected for this ad campaign can appear in the area below the ad campaign image.

In one embodiment, a user can connect a feed (for example: Collected, Ranked and Approved social media content within the Curation Queue) for the ad content. The user can associate any of the previously created feeds with the ad campaign. This can establish the social media content to be synchronized.

In one embodiment, a user creates an ad campaign including a campaign name, tags, URLs, and an image. Then the user can configure an ad content area in the content display or layout, and in the content display the user can select one or more tags and a feed to associate with the ad content area of the content display. Therefore once data from a feed, either an image or text is shown in the data portion of the content display, and the tags is associated with tags, if the tags match the tags that the user selected for their ads when they created the ads, the ads are then shown in the ad content area next to the content.

In one embodiment, when a user configures a part of the layout for an advertisement, the user can select one or more tags and a feed to associate with the section of the layout.

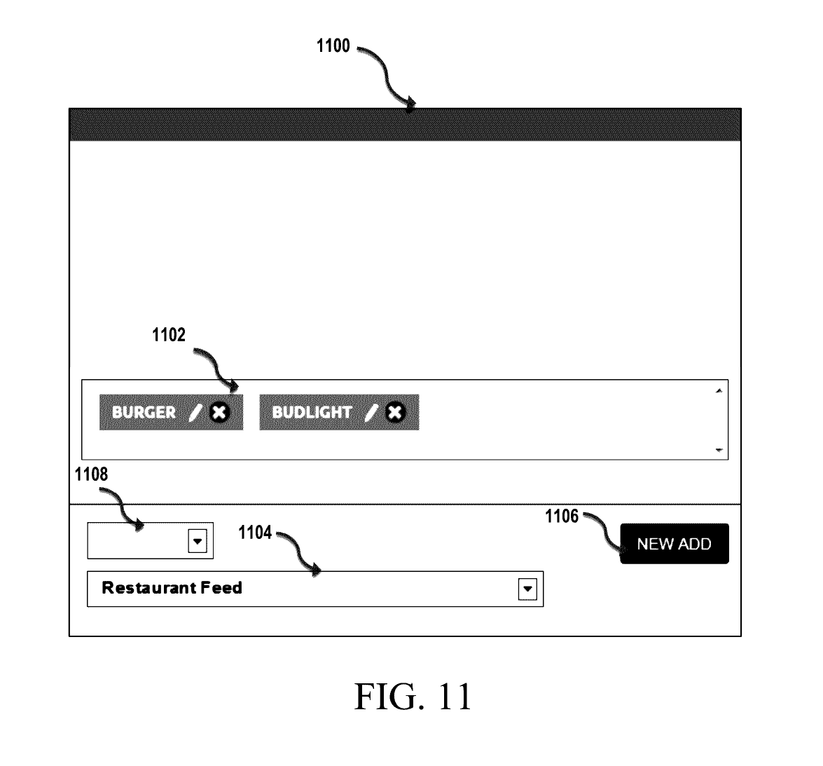

FIG. 11 is a widget feed configuration 1100. The widget feed configuration 1100 is the ad widget on the layout where the user actually determines what tags 1102 to use and the feed 1104. The user can also crate the new ad campaign here as well by clicking on New Add 1106. As shown in FIG. 11, the user can also select from the dropdown 1108 whether the user wants to use streaming social content or streaming social pictures.

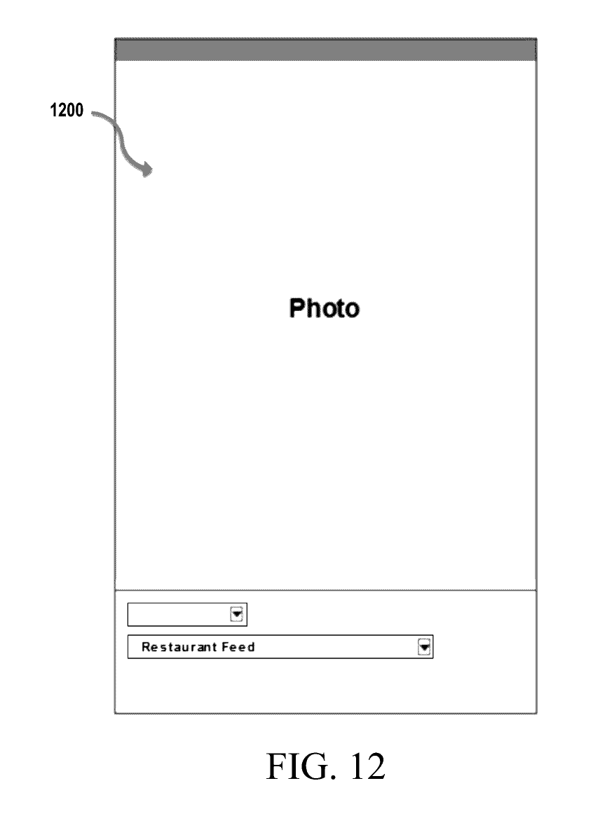

In one embodiment, social media content can be configured to sync to ad content. First, the user selects social media content. The user must select either streaming social pictures or the streaming social content to sync with their ads. Then the user selects a feed. For example, a user can pick a feed for the photo content 1200 as shown in FIG. 12.

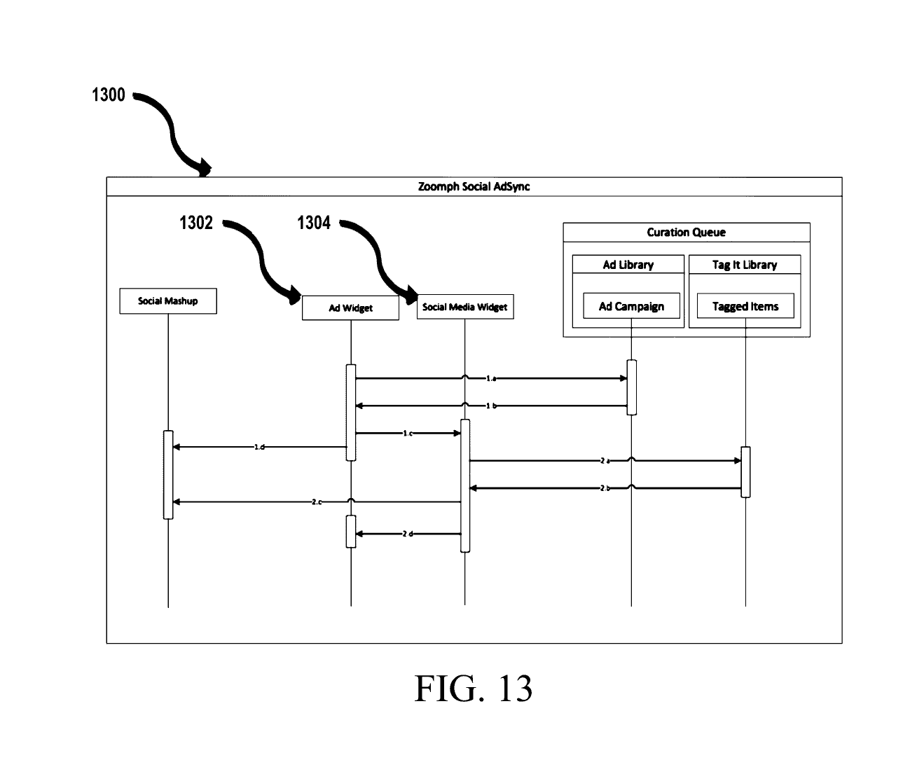

FIG. 13 is a sequence diagram 1300. In a first step, the ad content of the content display, or the Ad Widget 1302 of the layout initializes communication with a list of campaigns. The Ad Widget 1302 queries for an “Ad Campaign” from the “Ad” Library. The Ad Widget 1302 receives the “Ad Campaign” from the “Ad” Library. The Ad Widget 1302 extracts the Ad Campaign's tag attribute and notifies the “Social Media Widget” of the “Tag” to use for retrieval of social media content. The Ad Widget 1302 serves up the Ad Campaign imagery, along with the Ad Campaign hyperlink onto the content display.

In a second step, the social media widget 1304 responds to the communication. It queries approved social media items from the “Tag It Library” for batches of a predetermined number of one or more tagged items. For example the predetermined number can be 4. If the system finds more than a predetermined number of tagged social media items for a specific campaign, for example if the predetermined number is 4, and it found 6 items, the system grabs the necessary number of items for the rotation and recycled amongst Tagged Social Media items. It receives the tagged items from the Tag It Library. It displays items for designated batch on the content display, or Social Mashup as is described in the figure. Once all social media items have been displayed for an ad campaign, the Social Media Widget 1304 notifies the Ad Widget 1302 to query for the next “Ad Campaign”, hence starting the process again.

In one embodiment, if the system does not find any tagged items, the system will retrieve a predetermined number of untagged social media items from the approved queue to display. If the system finds less than a predetermined number of tagged items (i.e. a set of 3), the system will retrieve the remaining social media items (1 in this case) from the approved queue in order to complete its batch, while an ad campaign is displayed.

FIG. 14 illustrates a flowchart of an example process 1400. The process may be implemented by curation system 104 or engagement system 108.

At stage 1410, social media data is filtered for content resources that match one or more search terms. In an illustrative example, the user may be a company or organization that wishes to search for, collect, and use items of social media content that include the company's name or discuss the company's products or activities. The company may wish to use the items of content in connection with an advertisement campaign, for example. Accordingly, the user can generate one or more filters by using search terms. The search terms can be used to search social media data such as the data on Facebook, Instragram, and Twitter. The terms are compared to each piece of data on these platforms and if the terms match or are responsive to the content, the content is pulled from these platforms. In one embodiment, a hashtag or any other symbol can be used a part of the search terms. The content may be stored.

At stage 1420, a feed is generated based on the filtering, wherein the feed includes the content resources that match the search terms. The user can generate multiple feeds based on different search terms. A single feed can also include multiple search terms. Once a feed is generated which includes one or more search terms, it can be continuously updated to include any new content resources that match or are responsive to the search terms in the feed.

The user may examine each items of content and delete the item, approve the item, tag the item, etc. In the illustrative example, the company deletes some items, and approves and tags other items of content. Thus, at stage 1430, a content resource tag is associated with each content resource, the content resource tag describing the content resource. The tag can be associated with the content resource in a number of ways as describe above. The user can manually tag each content resource based on the text or the images in the content resource. The user can select one or more tags to use to tag the content resource. In one embodiment, the content resources can be automatically tagged using text recognition and/or image recognition. The tags are words that are similar to the text found in the text recognition. In one embodiment, the tags are words used to describe the image or images in the content resource. The tags are stored in association with the content resources.

In the illustrative example, the user now determines to use the items of content in a display. For example, the user may wish to display the items of content in the feed on a large screen television located in a sports venue, a conference center, a commercial mall, a retail store, a public space (such as Times Square in New York City), in a kiosk at a mall, in a movie theater, or in another location. The items of content in the feed may be displayed sequentially or in another arrangement. At one or more selected times, items of content may also be displayed along with one or more advertisements.

The user may select how and where on the display device the items of content will be displayed. Thus, at stage 1440, the feed is associated with a first section of a layout of a content display. The content display may be the content display 700 of FIG. 7. The user can select a layout of a content display. The content display can include one or more section and the sections can be populated with feed data, text or advertisement data. The user can designate where the feed data will be displayed on the content display. The user can also designate where the advertisements will be displayed on the content display. The first section can for example include a widget or a content widget with the functionality described.

The user may also prepare an advertisement campaign that will be displayed with one or more of the items of content in the feed. At stage 1450, an advertisement campaign is associated with a second section of the layout of content display, wherein the advertisement campaign includes one or more campaign tags and an advertisement image. The user can select the advertisement campaign to associate with the second section of the layout of the content display. The user can select to show more than one advertisements and therefore associate one campaign with one section of the layout and a second campaign with a second section of the layout. The second section can for example include a widget or an ad widget with the functionality described.

At stage 1460, the layout to be displayed is provided on a display device. The display device may be, for example, a large screen television or computer display located in a sports venue, a conference center, a commercial mall, a retail store, in a public space (such as Times Square in New York City), a kiosk at a mall, a movie theater, etc. The layout includes the various sections of text and advertisement data.

At stage 1470, the content resources from the feed are provided to be displayed in the first section of the layout, wherein each content resource is displayed in the layout for a predetermined amount of time. For example, all or a portion of a large screen located at a sports venue (e.g., a stadium) may be used to display items of content from the feed. These items of content may be displayed sequentially and continually during a sporting event or other live event, for example. When the layout is provided, the data displayed in the layout is continuously changing and updating. The section of the layout that includes the feed data displays the content resources from the feed, where each item is shown at a preset interval. If more than one section is associated with a feed, then the data from the second feed is shown in that section.

The user may also prepare an advertisement campaign that includes advertisement images to be presented along with items of content from the feed. In particular, from time to time, or at selected times, or when a determination is made that a predetermined event has occurred, advertisement images may be displayed simultaneously with selected items of content from the feed. Accordingly, at stage 1480, a determination is made that one of the content resources currently displayed in the first section of the layout is associated with a content resource tag that matches one of the campaign tags of the advertisement campaign. Curation system 104 may determine that a content resource, such as an image is displayed, that is associated with a content resource tag, such as a metadata tag, describing the content resource that matches one of the campaign tags of the advertisement campaign generated by a user. Curation system 104 can compare the campaign tag with the content resource tag to make this determination.

At stage 1490, the advertisement image is provided to be displayed in the second section of the layout based on the determining, wherein the advertisement image is displayed simultaneously with the content resource in the first section. When curation system 104 determines that the two tags match, or the two tags are a close match, the advertisement image associated with the ad campaign of the campaign tag is provided to be displayed in the layout of the content display. The advertisement is displayed while the content resource with the matching tag is displayed.

In one embodiment, the content resource associated with the content resource tag may be displayed at a predetermined time or upon the occurrence of a selected event. When the content resource is displayed, the advertisement image having the matching campaign tag is also displayed.

System 100 may be software, firmware, or hardware or any combination thereof in a computing device. A computing device can be any type of computing device having one or more processors. For example, a computing device can be a computer, server, workstation, mobile device (e.g., a mobile phone, personal digital assistant, navigation device, tablet, laptop, or any other user carried device), game console, set-top box, kiosk, embedded system or other device having at least one processor and memory. A computing device may include a communication port or I/O device for communicating over wired or wireless communication link(s).

Computing devices such as a monitor, all-in-one computer, smart phone, tablet computer, remote control, etc., may include a touch screen display that accepts user input via touching operations performed by a user's fingers or other instrument. For example purposes, a touch sensor grid may overlay the display area. The touch sensor grid contains many touch sensitive areas or cells that may be used to locate the area closest to the input of a user's touch.

Example touch operations using a touch screen display may include (but are not limited to) pinching, finger (or other stylus or object) touches, finger releases, and finger slides. Finger slides may be circular or any other shape, direction or pattern. The touch screen display may include a screen or monitor that may render text and/or images.

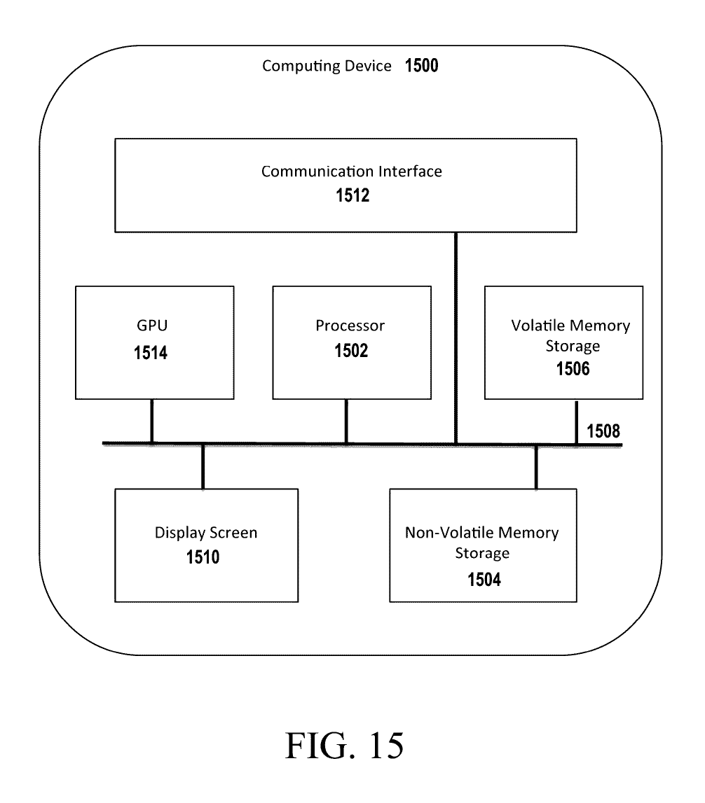

FIG. 15 is an example computer system 1500 in which embodiments of the present invention, or portions thereof, may be implemented as computer-readable code. For example, the components of systems 104 and 108 may be implemented in one or more computer systems 1500 using hardware, software implemented with hardware, firmware, tangible computer-readable media having instructions stored thereon, or a combination thereof and may be implemented in one or more computer systems or other processing systems. Components in FIGS. 1-14 may be embodied in any combination of hardware and software.

Computing devices, such as devices 110 or server 120, may include one or more processors 1502, one or more non-volatile storage mediums 1504, one or more memory devices 1506, a communication infrastructure 1508, a display screen 1510 and a communication interface 1512.

Processors 1502 may include any conventional or special purpose processor, including, but not limited to, digital signal processor (DSP), field programmable gate array (FPGA), application specific integrated circuit (ASIC), and multi-core processors.

GPU 1514 is a specialized processor that executes instructions and programs, selected for complex graphics and mathematical operations, in parallel.

Non-volatile storage 1504 may include one or more of a hard disk drive, flash memory, and like devices that may store computer program instructions and data on computer-readable media. One or more of non-volatile storage device 1504 may be a removable storage device.

Memory devices 1506 may include one or more volatile memory devices such as but not limited to, random access memory. Communication infrastructure 1508 may include one or more device interconnection buses such as Ethernet, Peripheral Component Interconnect (PCI), and the like.

Typically, computer instructions are executed using one or more processors 1502 and can be stored in non-volatile storage medium 1504 or memory devices 1506.

Display screen 1510 allows results of the computer operations to be displayed to a user or an application developer.

Communication interface 1512 allows software and data to be transferred between computer system 1500 and external devices. Communication interface 1512 may include a modem, a network interface (such as an Ethernet card), a communications port, a PCMCIA slot and card, or the like. Software and data transferred via communication interface 1512 may be in the form of signals, which may be electronic, electromagnetic, optical, or other signals capable of being received by communication interface 1512. These signals may be provided to communication interface 1512 via a communications path. The communications path carries signals and may be implemented using wire or cable, fiber optics, a phone line, a cellular phone link, an RF link or other communications channels.

Examples of systems, methods, and apparatus for collecting and curating social media content, and synchronizing displays of selected items of social media content and related advertisements are described in U.S. patent application Ser. No. 13/801,564, filed Mar. 13, 2013, which is incorporated herein by reference in its entirety and for all purposes.

Existing systems for displaying advertisements do not provide the capability to synchronize the display of advertisements with related items of social media content at venues where live events are held. Systems and methods described herein advantageously provide the capability to synchronize the display of advertisements with related items of social media content at venues where live events, such as sporting events, conferences, concerts, etc., are held.

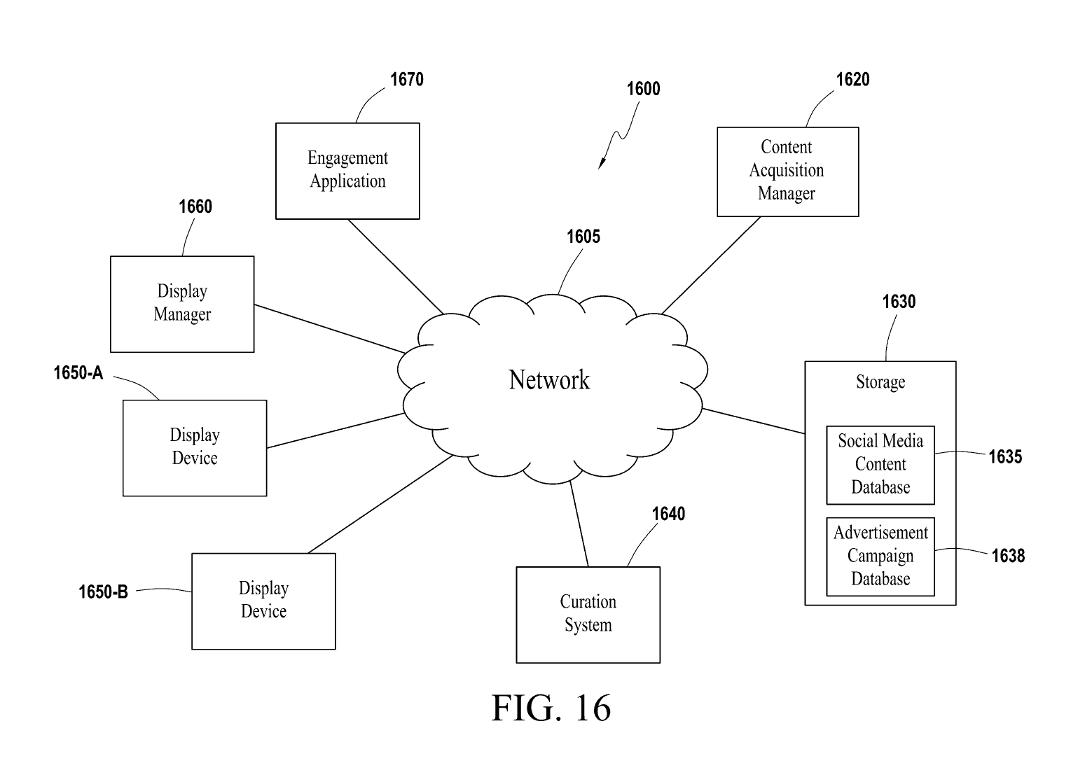

FIG. 16 shows a social content and advertisement synchronization system in accordance with an embodiment. System 1600 includes a network 1605, a content acquisition manager 1620, a storage 1630, a curation system 1640, a plurality of display devices 1650-A, 1650-B, etc., a display manager 1660, and an engagement application 1670.

Network 1605 may include, without limitation, the Internet and/or other types of networks such as a wireless network, a wide area network (WAN), a local area network (LAN), an Ethernet network, a storage area network, etc.

Content acquisition manager 1620 is connected to network 1605. Content acquisition manager 1620 accesses sources of social media content and searches for items of social media content that satisfy one or more parameters. For example, content acquisition manager 1620 may access social media websites such as Twitter, Facebook, Youtube, etc., and obtain tweets, images, posts, videos, etc., that contain a specified hashtag, contain a specified word, contain a specified image, etc. In an illustrative example, content acquisition manager 1620 may search for Facebook posts that contain the words “XYZ Company.” Content acquisition manager 1620 may compile a plurality of items of social media content into a feed. Content acquisition manager 1620 stores items of social media content in storage 1630.

Storage 1630 stores data including items of social media content. For example, items of social media content may be stored in a social media content database 1635 maintained in storage 1630.

Curation system 1640 functions in a manner similar to curation system 104 described above. Curation system 1640 enables users to access stored items of social media content and to curate these items in the manner described above. For example, a user may examine each item of social media content in one or more feeds, and either delete the item, tag the item, or perform another action with respect to the item. Curation system 1640 is similar to curation system 104 described above.

Each display device 1650 is adapted to display text, graphics, and other types of content. For example, display devices 1650-A, 1650-B may be televisions, very large-screen televisions (sometimes referred to as jumbotrons), display screens on computers or cell phones, smart TVs, Internet-enabled TVs, apps on television, etc.

Display manager 1660 access stored items of social media content and causes the content to be displayed on display devices 1650. Display manager 1660 may also cause other types of content, such as advertisements, to be displayed on display devices 1650.

Engagement application 1670 functions in a manner similar to engagement application 108 described above. Thus, for example, engagement application 1670 enables a user to access and interact with curation system 1640, and to manage social media content, via a user device.

A social content and advertisement synchronization system such as that described herein may be implemented in a variety of environments. For example, a social content and advertisement synchronization system may be used to collect and curate social media content, and display the curated social media content along with advertisements on a website available on the World Wide Web, via a personal computer or via a cell phone application.

In another embodiment, a social content and advertisement synchronization system may be used to collect and curate social media content, and display the curated social media content along with advertisements on a display device, in a synchronized manner, at a live event such as a sporting event, a conference, a meeting, a concert, a party, etc.

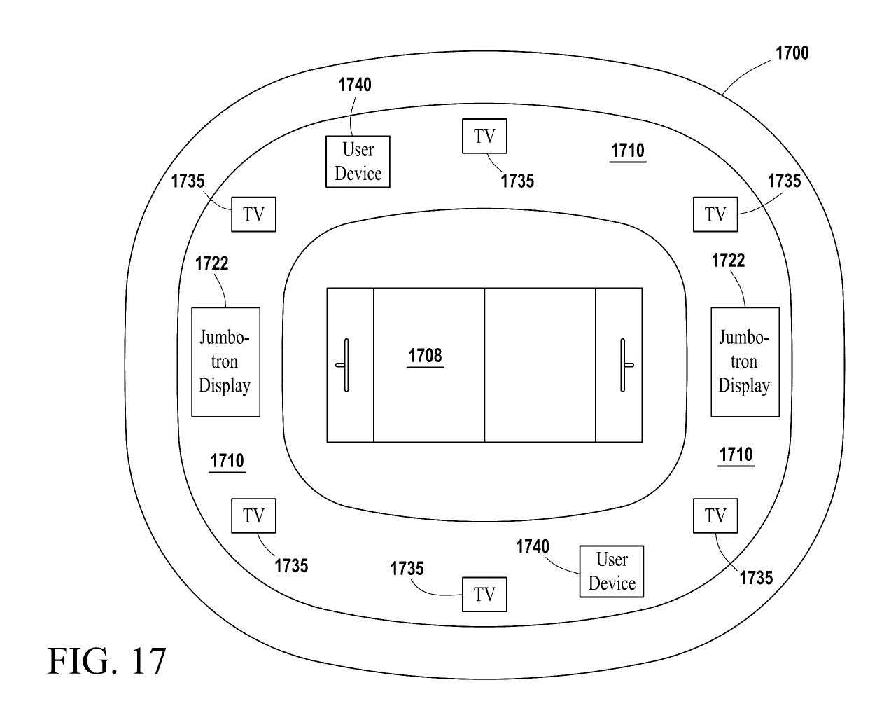

FIG. 17 shows a venue for a live event in accordance with an embodiment. Sports stadium 1700 includes a field of play 1708, which may be a football field, a baseball field, a basketball court, an ice rink, etc., and a spectator area 1710, which typically includes seating, bleachers, etc. A plurality of display devices are disposed at selected locations in the spectator area 1710. In the illustrative embodiment, the display devices include, without limitation, very large-screen jumbotron television screens 1722, regular television screens 1735, and user devices 1740, which may include cell phones, laptop computers, etc., carried by individuals. Some user devices 1740 may include a cell phone app adapted to receive and display items of social media content, and advertisements, from system 1600. In other embodiments, other types of display devices may be used, including smart TVs, Internet-enabled TVs, apps on television, etc.

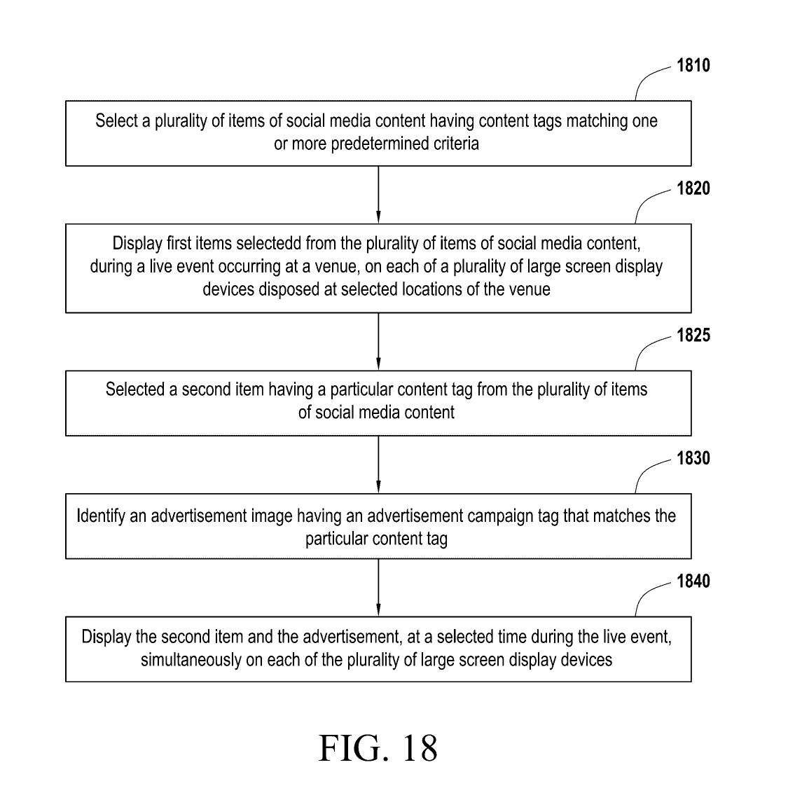

In accordance with an embodiment, previously curated social media content is displayed on the display devices during the sporting event. FIG. 18 is a flowchart of a method of displaying curated social media content on a display device during a live event in accordance with an embodiment. In the illustrative embodiment, a sports team organization, Team XYZ, uses social content and advertisement synchronization system 1600 to collect and curate items of social media content related to Team XYZ. Thus, in the manner described above, items of social media content including, for example, tweets, posts on personalized social media pages, photos, blog posts, etc., that mention Team XYZ or are related to Team XYZ are collected and stored in social media content database 1635. Team XYZ then curates the items by, for example, deleting undesired content items (including, for example, posts using profane language), approving selected content items, tagging selected content items, etc. For example, Team XYZ may add tags to selected items of social media content, such as a tag indicating “fans cheering at Team XYZ game,” a tag indicating “fan wearing Team XYZ jersey,” a tag indicating “vehicle with Team XYZ bumper sticker,” a tag indicating “President Obama at Team XYZ game,” etc.

Referring again to FIG. 17, when Team XYZ plays a game in stadium 1700, selected items of social content are retrieved and displayed on the various display devices located throughout stadium 1700. Thus, at step 1810, a plurality of items of social media content having content tags matching one or more predetermined criteria are selected. For example, curation system 1640 or engagement application 1670 may allow Team XYZ to specify one or more key words or other parameters, such as “fans cheering at Team XYZ game” and “fan wearing Team XYZ jersey.” Social media content database 1635 is accessed (by curation system 1640 and/or engagement application 1670), and approved items of social media content having tags matching the specified tags are retrieved and used to create a feed. Thus, in the illustrative embodiment, a feed of various photos may be generated showing fans cheering at Team XYZ games and fans wearing Team XYZ jerseys. The feed may include a sequence of photos and/or photos arranged in a mosaic arrangement.

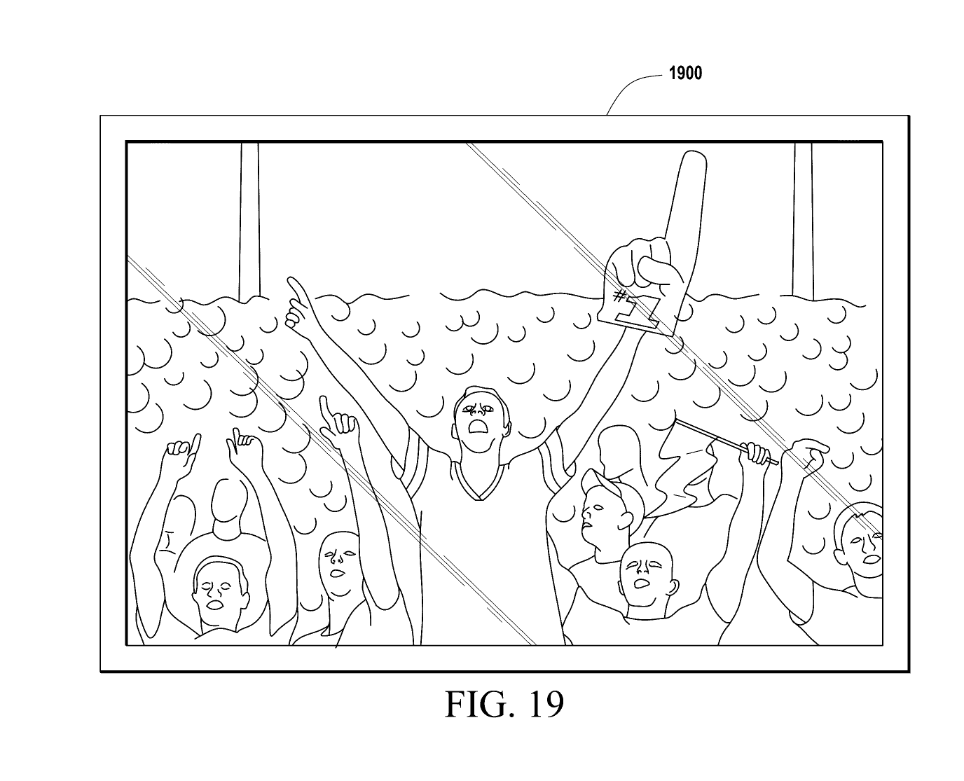

At step 1820, first items selected from the plurality of items of social media content are displayed, during a live event occurring at a venue, on each of a plurality of large screen display devices disposed at selected locations of the venue. Team XYZ may specify that photos of fans at Team XYZ games are to be shown continuously while the game is being played, from time to time, or at predetermined intervals. In the illustrative embodiment, display manager 1660 accesses social media content database 1635 and retrieves and displays items of social media content based on the user's input. FIG. 19 shows a photo of fans cheering during a game displayed on a display device 1900, which may be a jumbotron television, for example. In the illustrative embodiment, the photos in the feed are displayed on jumbotron displays 1722, on TVs 1735, and on user devices 1740, while game play is occurring. The items in the feed may be displayed on all the display devices in the stadium. Furthermore, photos may be displayed individually in sequence, or multiple photos may be displayed as a mosaic on each particular screen. As the feed is updated, new or additional photos may be displayed. The photos may be displayed using all or a portion of a display screen.

While in the illustrative embodiment, photos are displayed, in other embodiments, other types of social media content items may be retrieved and displayed, such as tweets, posts, videos, articles, designs, etc. A feed may include any type of social media content.

Team XYZ may further wish to display advertisements for a team jersey that is selling in local stores. Thus, prior to the sporting event, an advertisement campaign for the team jersey, including advertisement images, for the Team XYZ jerseys, is prepared in the manner described above. A tag “fan wearing Team XYZ jersey” is added to the advertisement campaign. Referring to FIG. 16, the advertisement images and advertisement campaign tags may be stored in advertisement campaign database 1638 in storage 1630.

Prior to the sporting event, Team XYZ further specifies that when any item of social media content having the tag “fan wearing Team XYZ jersey” appears on the display screens, the advertisement image associated with the advertisement campaign is to be displayed on the screen along with the social media content.

At step 1825, a second item having a particular content tag is selected from the plurality of items of social media content. In the illustrative embodiment, Team XYZ may specify that the photos having a tag “fan wearing Team XYZ jersey” are to be displayed on the display devices at a particular time during the sporting event—e.g., when halftime begins in a football game, between the second and third innings of a baseball game, etc. Accordingly, display manager 1660 retrieves items of social media content having a tag “fan wearing Team XYZ jersey.” These items may include photos or other types of content.

At step 1830, an advertisement image having an advertisement campaign tag that matches the particular content tag is identified. Team XYZ also specifies that the advertisement image relating to the team jersey advertisement campaign, which also has the matching tag “fan wearing Team XYZ jersey,” is to be displayed along with the photos having the tag “fan wearing Team XYZ jersey.” Display manager 1660 accesses advertisement campaign database 1638 and retrieves an advertisement image having the tag “fan wearing Team XYZ jersey.” At step 1840, the second item and the advertisement image are displayed, at a selected time during the live event, simultaneously on each of the plurality of large screen display devices. Display manager 1660 causes the second item and the advertisement image to be displayed together at a selected time, such as at 2:30 PM during the live event. Alternatively, the second item and the advertisement image may be displayed simultaneously upon the occurrence of a selected event during the live event.

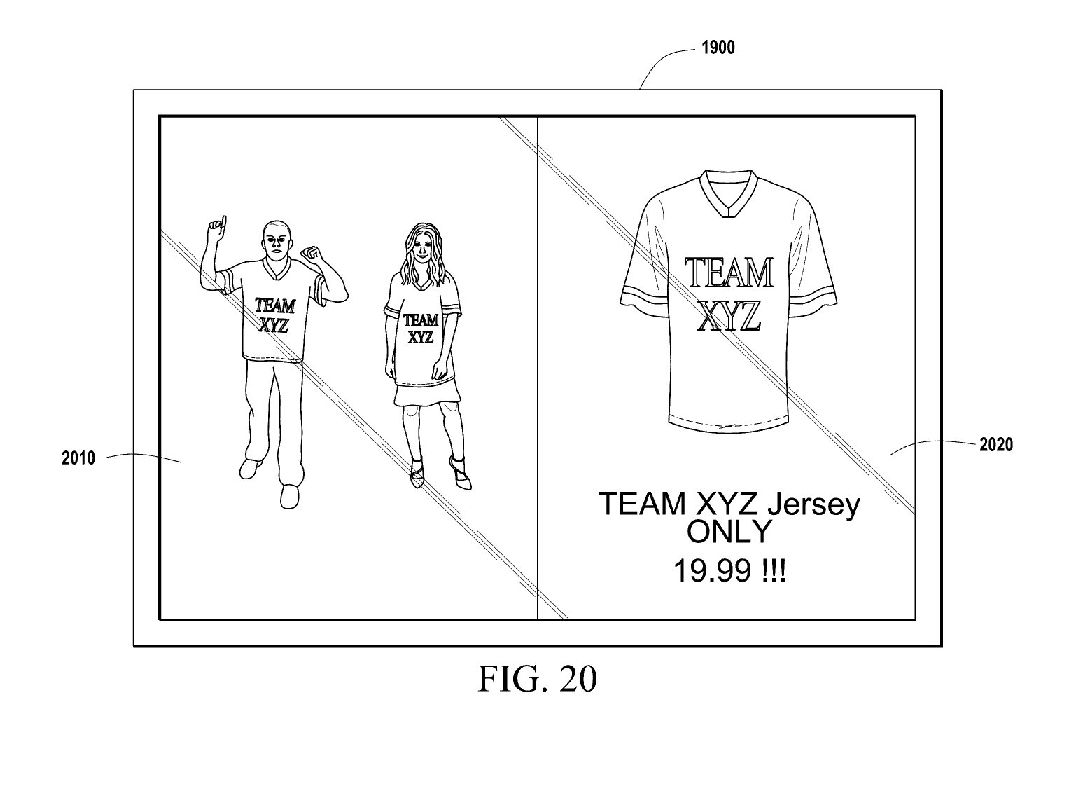

In the illustrative example, the selected event is the beginning of halftime during a football game. Thus, when halftime begins, a photo having the tag “fan wearing Team XYZ jersey” is selected from the feed and displayed on the display screens in the stadium. FIG. 20 shows a photo of fans wearing Team XYZ jerseys and an advertisement image for the Team XYZ jersey displayed on a display device. The photo is displayed in a first portion of the screens (e.g., the left side of the screens), and the advertisement image is displayed in a second portion of the screens (e.g., the right side of the screens), alongside the photo.

While in the illustrative embodiment, data relating to social media content, advertisement campaign data, and tags are stored in one or more databases, in other embodiments, data may be stored in other forms. For example, in another embodiment, social media content objects and advertisement objects may be used to store data. For example, a social media content data store may be created in storage 1630 (or elsewhere) to store a plurality of social media content objects, where each social media content object includes an item of social media content and a social media content tag. Similarly, a plurality of advertisement objects may be created and stored in an advertisement campaign store, where each advertisement object storing an advertisement image and an advertisement campaign tag. Curation system 1640 and/or engagement application 1670 may create and manage such objects.

While systems and methods have been described herein in the context of a sporting event, the systems and methods described herein may be implemented in other live events including conferences, concerts, parties, etc. For example, during a conference held at a conference venue (e.g., a hotel, a conference center, etc.), a feed of social media content items may be displayed on display screens located at various locations in the conference venue. Then, between the presentations of two keynote speakers during the conference, selected items of social media content having a particular tag, and advertisements images having matching tags, may be displayed simultaneously on the display screens.

Embodiments also may be directed to computer program products comprising software stored on any computer-useable medium. Such software, when executed in one or more data processing device, causes a data processing device(s) to operate as described herein.

Embodiments of the invention employ any computer-useable or readable medium. Examples of computer-useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

Embodiments of the invention and all of the functional operations described in this specification may be implemented in digital electronic circuitry, or in computer software, firmware, or hardware, including the structures disclosed in this specification and their structural equivalents, or in combinations of one or more of them. Embodiments of the invention may be implemented as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein.

The breadth and scope of the present invention should not be limited by any of the above-described exemplary embodiments or any actual software code with the specialized control of hardware to implement such embodiments, but should be defined only in accordance with the following claims and their equivalents.

What is claimed is:

1. A system comprising:
a plurality of large screen display devices located at a venue;
a storage adapted to store one or more items of social media content having respective content tags and one or more advertisement images having respective advertisement campaign tags; and
one or more processing devices adapted to:
select a plurality of items of social media content having content tags matching one or more predetermined criteria;
cause first items selected from the plurality of items of social media content to be displayed, during a live event occurring at the venue, on each of the plurality of large screen display devices;
select a second item having a particular content tag from the first plurality of items of social media content;
identify an advertisement image having an advertisement campaign tag that matches the particular content tag of the second item;
cause the second item and the advertisement image to be displayed, upon the occurrence of a selected event during the live event, simultaneously on each of the plurality of large screen display devices.

2. The system of claim 1, wherein:
the plurality of large screen display devices include a jumbotron television screen; and
the venue is a venue for sporting events.

3. The system of claim 2, wherein the selected event is one of a halftime of a game, a time between innings of a baseball game, and an interval between speeches by speakers at a conference.

4. The system of claim 1, wherein the plurality of items of social media content include one of a photo, a blog post, a tweet, and a video.

5. The system of claim 1, wherein the live event is one of a sporting event, a conference, a concert, and a party.

6. The system of claim 1, wherein the one or more processing devices are further adapted to:
obtain the one or more items of social media content from one or more social media websites;
enable a user to tag the one or more items of social media content to generate tagged items of social media content; and
store the tagged items of social media content.

7. The system of claim 1, wherein the second item is displayed in a first region of each large screen display device and the advertisement image is displayed in a second region of the each large screen display device.

8. A method comprising:
selecting a plurality of items of social media content having content tags matching one or more predetermined criteria;
displaying first items selected from the plurality of items of social media content, during a live event occurring at a venue, on each of a plurality of large screen display devices located at the venue;
selecting a second item having a particular content tag from the first plurality of items of social media content;
identifying an advertisement image having an advertisement campaign tag that matches the particular content tag of the second item; and
displaying the second item and the advertisement image, upon the occurrence of a selected event during the live event, simultaneously on each of the plurality of large screen display devices.

9. The method of claim 8, wherein:
the plurality of large screen display devices include a jumbotron television screen; and
the venue is a venue for sporting events.

10. The method of claim 9, wherein the selected event is one of a halftime of a game, a time between innings of a baseball game, and an interval between speeches by speakers at a conference.

11. The method of claim 8, wherein the plurality of items of social media content include one of a photo, a blog post, a tweet, and a video.

12. The method of claim 8, wherein the live event is one of a sporting event, a conference, a concert, and a party.

13. The method of claim 8, further comprising:
obtaining the one or more items of social media content from one or more social media websites;
enabling a user to tag the one or more items of social media content to generate tagged items of social media content; and
storing the tagged items of social media content.

14. The method of claim 8, further comprising:
displaying the second item in a first region of each large screen display device; and
displaying the advertisement image in a second region of the each large screen display device.

15. A non-transitory computer readable medium having program instructions stored thereon, that, in response to execution by a computing device, cause the computing device to perform operations comprising:
selecting a plurality of items of social media content having content tags matching one or more predetermined criteria;
causing first items selected from the plurality of items of social media content to be displayed, during a live event occurring at the venue, on each of the plurality of large screen display devices;
selecting a second item having a particular content tag from the first plurality of items of social media content;
identifying an advertisement image having an advertisement campaign tag that matches the particular content tag of the second item;
causing the second item and the advertisement image to be displayed, upon the occurrence of a selected event during the live event, simultaneously on each of the plurality of large screen display devices.

16. The non-transitory computer readable medium of claim 15, wherein:
the plurality of large screen display devices include a jumbotron television screen; and
the venue is a venue for sporting events.

17. The non-transitory computer readable medium of claim 16, wherein the selected event is one of a halftime of a game, a time between innings of a baseball game, and an interval between speeches by speakers at a conference.

18. The non-transitory computer readable medium of claim 15, wherein the plurality of items of social media content include one of a photo, a blog post, a tweet, and a video.

19. The non-transitory computer readable medium of claim 15, wherein the live event is one of a sporting event, a conference, a concert, and a party.

20. The non-transitory computer readable medium of claim 15, the operations further comprising:
obtaining the one or more items of social media content from one or more social media websites;
enabling a user to tag the one or more items of social media content to generate tagged items of social media content; and
storing the tagged items of social media content.

21. A system for managing social media content and advertisements, the system comprising:
a processor;
a memory communicatively coupled to the processor;
a social media content data store, communicatively coupled to the processor, configured to store a plurality of social media content objects, a social media content object comprising an item of social media content and a social media content tag;
a social media content object manager component communicatively coupled to the social media content data store, the social media content object manager component configured to receive information related to a particular item of social media content, and create and store in the social media content data store a social media content object comprising the particular item of social media content and an associated social media content tag;
a social media content and advertisement display component configured to:
select a plurality of first social media content objects having first items of social media content and first tags, and display the first items of social media content on a plurality of display devices located in a venue;
select a second social media content object having a second item of social media content and a second tag and an advertisement having a third tag matching the second tag, and display the second item of social media content and the advertisement simultaneously on the plurality of display devices.
